(19) United States
(12) Patent Application Publication
(10) Pub. No.: US 2010/0010822 A1
(43) Pub. Date: Jan. 14, 2010

(54) SOCIAL PRODUCT ADVERTISEMENTS

(75) Inventors: HRISHIKESH BAL, BELLEVUE, WA (US); MICHAEL WALDMAN RECKHOW, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/172,000

(22) Filed: Jul. 11, 2008

(51) Int. Cl. G06Q 10/00; G06F 17/30

(52) U.S. Cl. 705/1; 707/104.1; 707/E17.134

(57) ABSTRACT

A method, data structure, and medium are provided for generating and presenting advertisements to users through a social networking web site. Objective information describing a product is received from a promoter, and subjective information describing the product is received from users of the social networking web site. An advertisement is then generated by combining the information received from the promoter and the users of the social networking web site. Ratings are calculated for each of a plurality of advertisements and analyzed to select advertisements to present to a user through the social networking web site.

### BACKGROUND

Social networking websites allow users to form connections with other users. The connections can be formed, for example, because of a shared common interest or background. The social networking websites provide a variety of avenues for users to interact with each other and form or maintain relationships. A user can join or form a social network with other users that share common interests or backgrounds. While some social networking websites display advertisements, the advertisements are often not sufficiently targeted to users and often do not provide information that draws the user's attention to the products and services that are the subject of the advertisements.

### SUMMARY

Embodiments of the invention relate to generating and presenting advertisements to users through a social networking website. In a first aspect, a method for generating an advertisement embodied on a computer-readable medium for presentation to a user through a social networking website is provided. Objective information describing a product is received from a promoter of the product. Information describing the product is received from users through the social networking website. The advertisement is generated for the product by combining the objective information received from the promoter and information received from the users.

In a second aspect, a data structure embodied on a computer-readable medium is provided for storing an advertisement. The data structure is comprised of a first data section and a second data section. The first data section includes objective information describing a product, as provided by a promoter of the product. The second data section includes information pertaining to the product provided by users of a social networking web site.

In a third aspect, computer-storage media with instructions embodied thereon for performing a method of selecting advertisements to present to a user of a social networking website is provided. A determination is made of which advertisements are available for presentation to a user of a social networking web site. A rating is calculated for each of the advertisements based on the revenue that their presentation will generate. A rating is also calculated for each of the advertisements based on a user engagement score. Both of the calculated ratings are then analyzed and advertisements are selected for presentation to the user based on the analysis.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a diagram depicting a data structure for use in implementing embodiments of the present invention;

FIG. 3 is a system diagram illustrating the relationship of social network users to a server in accordance with an embodiment of the invention;

FIG. 4 is a diagram illustrating an exemplary advertisement in accordance with an embodiment of the invention;

FIG. 5 is a diagram illustrating an exemplary advertisement in accordance with an embodiment of the invention;

FIG. 6 is a flow diagram illustrating a method of generating an advertisement in accordance with an embodiment of the invention; and

FIG. 7 is a flow diagram illustrating a method of selecting an advertisement to present to a user of a social networking website, according to one embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to generating advertisements based on objective information pertaining to a product and other information provided by one or more users through a social networking web site. The users providing the other information can belong to the same social network within the social networking web site. In some embodiments, advertisements are selected for presentation through the social networking web site to users belonging to the same social network according to calculated ratings. The ratings may take into account the amount of revenue that will be generated by the presentation of the advertisements and a user engagement score.

Having briefly described an overview of embodiments of the present invention, an exemplary operating environment suitable for use in implementing embodiments of the present invention is described below.

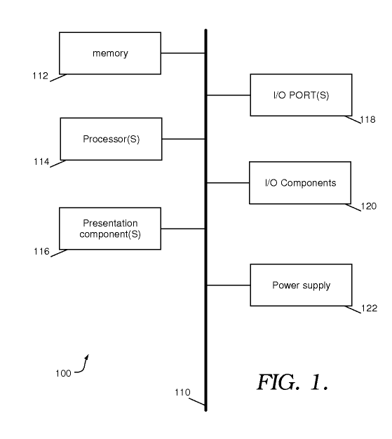

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

Social networking websites allow users to form connections with other users. Examples of social networking websites are FACEBOOK, MYSPACE, and FRIENDSTER, just to name a few. Users create profiles on the social networking web site that include information about the user, such as biographical information, interests, hobbies, or educational information. Included in these profiles can be forms of audio and visual media, either created by the user or obtained from another source. For instance, images of the user can be included in the user's profile.

The connections between users can be formed, for example, because of a shared common interest or activities between a group of users. Users can form connections between one another on both a group and individual basis. For instance, users can associate with one another on an individual basis by a first user issuing a request to a second user to list their status as “friends” or a functional equivalent thereof. When the second user consents to the request, a connection is formed between the first and second users. In effect, this connection is a social network with the first and second users being the only members.

Users can form connections between each other on a group basis as well. Users accomplished this by forming or joining social networks within a social networking web site. Specific social networks can be created for a variety of specific interests. Users belonging to a social network are therefore associated with one another. For instance, fans of a particular athletic team or club can form and join a social network for similarly situated individuals. Alumni and alumnae of an educational institution can likewise form and join a social network. Any common interest or similar background can be used as the basis for generating and joining a social network. Further, a single user can belong to multiple social networks within the social networking web site and is not limited to being a member of only one social network.

A variety of methods are provided by the social networking websites for users to interact with each other and maintain or form relationships. Examples of these are activity feeds that alert other users when a user in their social network performed an action, such as updating their profile. Users may also send messages to each other, either through methods analogous to email or instant messaging. The profiles of users can also permit other users to post comments to the user's profile.

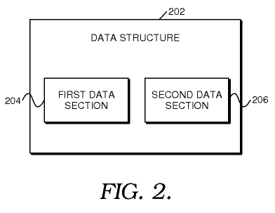

In accordance with embodiments of the present invention, advertisements are generated for presentation within social networking sites. The advertisements include objective information provided by a promoter of a product or service (e.g., the advertiser) as well as subjective information provided by one or more users of the social networking sites. Turning now to FIG. 2, a block diagram depicting a data structure for use in implementing embodiments of the invention is presented. The data structure 202 can be embodied on a computer readable medium for storing information to generate an advertisement to present to one or more users through a social networking web site.

Data structure 202 contains a first data section 204. First data section 204 contains objective information describing a product provided by a promoter of the product. A promoter can be a manufacturer of the product, or a retailer selling the product, or any other party that serves to benefit by a sale of the product. This information provided by the promoter can be limited to that which is clearly objective.

While specific mention is made to a product as being the subject of the advertisement, services could also be the subject of the advertisement, according to embodiments of the present invention.

The data structure 202 also contains a second data section 206. The second data section 206 contains information pertaining to the product that is provided by one or more users through the social networking web site and will be discussed in greater detail below. The information provided by the users is more subjective in nature, such as the user's rating of the product or their own experiences with the product. In turn, advertisements may be generated from the data structure 202 and presented to one or more users through the social networking web site. The advertisements can be presented in conjunction with one of the methods of communication, described above, provided by the social networking web site. For instance, when a user provides information describing their experiences with a product, a notice could be generated in the user's activity feed.

An advertisement generated using the data structure 202 can be communicated to other users belonging to the same social networks as the user so that the other users are made aware of the user providing information about the product. Therefore, when a first user provides information about his/her experiences with a product, other users belonging to the same social networks as the first user can be made aware of the event and be presented with a notice or advertisement. The other users can then provide information about their own experiences with the product as well, and the process repeats itself.

In some embodiments, specific advertisements can be generated for a particular user. The advertisements can include information provided only by the other users belonging to one of the same social networks as the particular user (e.g., “friends” of the user within the social networking site). In this manner, the particular user may be more likely to be responsive to the advertisement since other users belonging to the same social network have provided comments concerning the product. Instead of being presented with comments from users that the particular user may have no connection with, comments are only presented from users with which the particular user has a known connection.

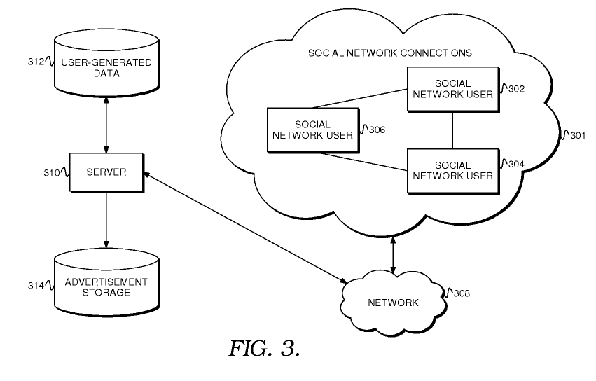

With reference now to FIG. 3, a system diagram is presented which illustrates the relationship of social network users to a server, according to embodiments of the invention. Included in system 300 are social network users 302, 304, and 306 belong to social network 301. While only three social network users 302, 304, and 306 are depicted as belonging to social network 301, any number of users can belong to the social network 301. In addition, social network users 302, 304, and 306 can belong to any number of different social networks, not depicted in FIG. 3.

Social network 301 can be defined by a common interest or background that the social network users 302, 304, and 306 share. For instance, social network 301 can be defined for fans of a particular athletic team or club, or alumni and alumnae of a particular educational institution. Any number of social networks can be created by users of the social networking web site. Users of the social networking web site can belong to as many different social networks as they desire.

The social network 301 is communicatively coupled by a network 308 to a server 310. The network 308 is of the communications type, and not the social type described above. Network 308 can be the internet, a local area network (LAN), or a wide area network (WAN), for instance. The server 310 performs the functions of generating and communicating information to facilitate the social network users 302, 304, and 306 interaction with the social networking web site. The server 310 can be of the type generally known as a web server.

The server 310 is communicatively coupled to a user-generated data store 312 and an advertisement storage 314. While depicted as being separate from the server 310, the user-generated store 312 and the advertisement storage 314 can be located within the server 310. The user-generated data store 312 can include the information submitted by users describing their experiences with a product, as described above in relation to FIG. 2. Alternatively, this information can be stored in addition to or in conjunction with the objective information describing the product in the advertisement storage 314.

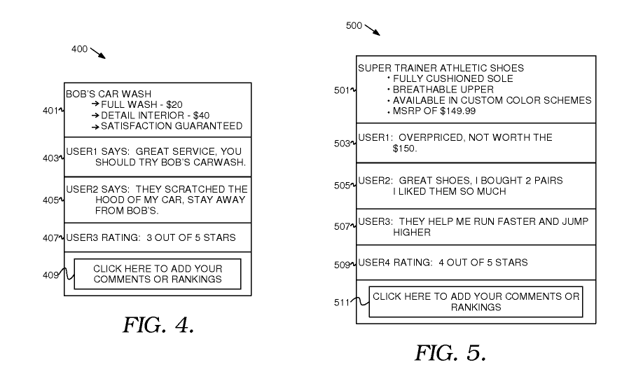

With reference now to FIG. 4, a diagram of an exemplary advertisement is presented in accordance with embodiments of the invention. Advertisement 400 includes objective information 401 describing a product or service that is the subject of the advertisement 400. The objective information 401 is generally provided by a promoter of the product. The objective information 401 can include, for instance, a title of the product or service, along with other objective information pertaining to the subject of the advertisement. In the example provided in FIG. 4, the objective information 401 provides a name of the subject of the advertisement 400, “Bob's Car Wash.” Also provided is detailed information regarding the pricing structure at “Bob's Car Wash,” along with a guarantee of satisfaction. Although not depicted in FIG. 4, an image of “Bob's Car Wash” could be provided in objective information 401, and/or the location or other contact information could be provided as well.

In other information fields 403, 405, and 407, information is presented that was provided by users of the social networking web site. This information can be subjective in nature, such as the accolade provided by “USER1” in other information field 403. In other instances, a user can inform other users of their dissatisfaction with the subject of the advertisement 400. This is the case in the other information field 405. In other information field 407, a user has provided a rating of the subject of the advertisement 400.

Upon being presented with the advertisement 400, a user can chose to add to the advertisement by selecting the button 409. The selection can be effectuated through a user input device on a computing device. Once the button 409 has been selected by the user, the user is able to add comments or ratings regarding the subject of the advertisement 400. This information is then stored in the data structure along with information provided by the other users. When the advertisement is presented again, the comments provided by the user may be presented.

In various embodiments of the present invention, different information may be presented with an advertisement to different users of a social networking site. For instance, in one embodiment, if the advertisement is presented to a user that does not belong to the same social network as the user who provided the information (e.g., the users are not “friends” or a functional equivalent within the social networking site), the information will not be presented. Alternatively, if both the user which provided the information and the user to whom the advertisement is being presented are both members of the same social network (e.g., the users are “friends” or a functional equivalent within the social networking site), the information provided by the user is presented as part of the advertisement. Other criteria can also be applied in determining the amount of information to present. For instance, only the most recent information provided by users may be presented. In addition, a proportionate share of positive and negative information can be provided, so as to provide a realistic picture of all information provided by users of the product within the same social network.

In embodiments of the invention where the advertisement is presented to a user that does not belong to the same social network as the user who provided the information (e.g., the users are not “friends” or a functional equivalent within the social networking site), the information can be presented in order to show a global perspective of information that is not limited to users that are “friends” or a functional equivalent within the social networking site.

Turning now to FIG. 5, a diagram of another exemplary advertisement is presented, according to an embodiment of the present invention. Advertisement 500 includes objective information 501 describing the product or service that is the subject of the advertisement 500. The objective information 501 may be provided by a promoter of the product or service associated with the advertisement. The objective information 501 can include, for instance, a title of the product or service, along with other objective information pertaining to the subject of the advertisement. In the example provided in FIG. 5, the objective information 501 provides a name of the subject of the advertisement 500, “Super Trainer Athletic Shoes.” Also provided is detailed information regarding characteristics and properties of “Super Trainer Athletic Shoes,” along with the manufacture's suggested retail price of the product.

In other information fields 503, 505, 507, and 509, information is presented that was provided by users of the social networking web site. This information can be subjective in nature, such as the criticism provided by “USER1” in other information field 503.

In other information fields 505 and 507, a user has expressed their satisfaction with subject of the advertisement 500. In other instances, such as in other information field 509, a user can provide a rating of the subject of the advertisement 500.

Upon being presented with the advertisement 500, a user can chose to add to the advertisement by selecting the button 511. The selection can be effectuated through a user input device on a computing device. Once the button 511 has been selected by the user, the user is able to add comments or ratings regarding the subject of the advertisement 500.

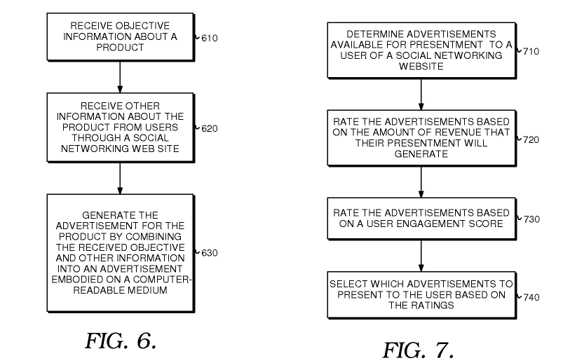

With reference now to FIG. 6, a flow diagram is presented to illustrate a method of generating an advertisement in accordance with an embodiment of the invention. The method can be embodied on a computer readable medium and provide for the presentation of the advertisement to a user through a social networking web site.

In block 610, objective information describing a product is received. The objective information can be received from a promoter of the product. A promoter can be a manufacturer of the product, or a retailer selling the product, or any other party that serves to benefit by a sale of the product. While specific mention is made to a product as being the subject of the advertisement, services could also be the subject of the advertisement, according to embodiments of the present invention. As described above, the objective information can include, for instance, the name or price of the product, characteristics of the product, an image of the product, and/or a link to a web page of third party that sells the product.

In block 620, other information describing the product is received from users. The other information is received from the users through a social networking web site. The information can be received in response to a user viewing an advertisement, as described in relation to FIGS. 3 and 4 above. The information can include, for instance, the user's experience with the product and/or their rating of the product against a scale.

In block 630, an advertisement is generated for the product by associating the received objective information and the subjective user information and storing the information on a computer-readable medium. When presented, the advertisement can include a portion for the objective information that is separate from a portion containing information provided by other users.

Turning now to FIG. 7, a flow diagram is presented to illustrate a method of selecting an advertisement to present to a user of a social networking web site, according to an embodiment of the invention. Computer executable instructions embodied on a computer readable medium can be provided for performing the method.

In block 710, a determination is made of which advertisements are available for presentation to the user of the social networking web site. This determination can be made by examining an advertising storage database of the type depicted in FIG. 3.

At block 720, a calculation is made of the rating of the revenue that can be generated by the presentation of the advertisements determined to be available in block 710. For instance, the cost of displaying the advertisement can be determined by the number of times it is presented to distinct users. Advertisements would then be ranked accordingly, with advertisements that generate greater revenue for the social networking web site being ranked higher than those that generate less revenue.

In block 730, a calculation is made of the rating of a user engagement score of each of the advertisements determined to be available in block 710. The calculation of the user engagement score can involve determining a first user's history of interaction with each of the advertisements. Interactions with an advertisement can include being presented with the advertisement, adding information to the advertisement, purchasing the product promoted by the advertisement, or clicking on a link for the advertisement. These interactions can be tracked by the social networking web site through the use of cookies or other tracking methods known to those skilled in the art.

Additionally, different weighting can be applied to each interaction. For instance, a higher weight can be applied to the purchasing of the product, as opposed to the presentation to a user of an advertisement for the product.

The history of other users' interactions, which belong to the same social network as the first user, with the advertisements is determined as well. The user engagement score is then calculated based on the user's and other users' interaction with the advertisement. Different weighting factors can be applied to both the user's and other users' interactions. A higher score can indicate a higher likelihood that the user will respond to or find useful the advertisement. In this manner, a high user engagement score correlates with products and associated advertisements that have been well received by the user and other users. For example, if other users in the user's social network have regularly interacted with ads for a specific type of golf club, and the user has interacted with the advertisement as well, a relatively high user engagement score results.

In block 740, the one or more of the advertisements determined to be available in block 710 are selected by analyzing the calculated ratings determined in block 720 and 730. The analysis can apply weighting factors to each of the calculated ratings. The one or more selected advertisements are then presented to the user through the social networking web site.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. A method of generating an advertisement embodied on a computer readable medium for presentation to a user through a social networking web site, the method comprising:
receiving objective information describing a product, wherein the objective information is received from a promoter of the product;
receiving other information describing the product from one or more users, wherein the information is received from the one or more users through the social networking web site;
generating the advertisement for the product by combining the received objective information and other information and storing it on a computer readable medium.

2. The method of claim 1, wherein the objective information describes properties of the product.

3. The method of claim 1, wherein the received other information describes a user's experience with the product.

4. The method of claim 1, wherein the received other information includes a user's rating of the product.

5. The method of claim 1, further comprising:
presenting the generated advertisement for the product to a user of a social networking website;
receiving additional other information from the user subsequent to an initial presentation of the generated advertisement for the product; and
incorporating the additional other information in the generated advertisement for presentation to the user and further users.

6. The method of claim 1, wherein the other information is received from a plurality of users, and wherein the plurality of users are members of the same network within the social networking web site.

7. The method of claim 7, wherein the generated advertisement is presented to one or more users that are members of the same network within the social networking web site.

8. A data structure embodied on a computer-readable medium for storing an advertisement to present to one or more users through a social networking web site, the data structure comprising:
a first data section including objective information describing a product, wherein the objective information is provided by a promoter of the product; and
a second data section including information pertaining to the product, wherein the information is provided by one or more users through a social networking web site, wherein the data structure is presented to the one or more users through the social networking web site.

9. The data structure of claim 8, wherein the information contained in the second data section is supplied by one or more users that each belong to the same network within a social networking web site and the data structure is presented to the one or more users that each belong to the same network.

10. The data structure of claim 8, wherein the information included in the first data section describes objective properties of the product.

11. The data structure of claim 8, wherein the information included in the second data section is provided by a user through a social networking web site.

12. The data structure of claim 11, wherein the information included in the second data section describes a user's experience with the product.

13. The data structure of claim 11, wherein the information included in the second data section describes a user's rating of the product.

14. The data structure of claim 11, wherein the information included in the second data section describes a user's interaction with an advertisement for the product.

15. One or more computer-readable storage media with computer executable instructions embodied thereon for performing a method of selecting one or more advertisements to present to a user of a social networking web site, the method comprising:
determining one or more advertisements available for presentation to a user of a social networking web site;
calculating a first rating of each of the one or more advertisements based on an amount of revenue that presentation of each advertisement is expected to generate;
calculating a second rating of each of the one or more advertisements based on a user engagement score; and
selecting one or more advertisements to present to the user by analyzing the first and second ratings of the one or more advertisements.

16. The one or more computer-readable storage media of claim 15, wherein the amount of the revenue that the presentation of an advertisement is expected to generate is determined by the cost paid by an advertiser per click on the advertisement.

17. The one or more computer-readable storage media of claim 15, wherein determining a user engagement score comprises:
determining a first user's history of interaction with each of the one or more advertisements;
determining other users' history of interaction with each of the one or more advertisements, wherein the other users and the first user are associated with one another on the social networking web site; and
calculating a user engagement score based on the user's and other users' interaction with each of the one or more advertisements.

18. The one or more computer-readable storage media of claim 17, wherein the first user and the other users are associated with one another on the social networking web site through membership in a common network of users.

19. The one or more computer-readable storage media of claim 17, wherein selecting one or more advertisements to present to the user further comprises:
generating a list of advertisements to present to the user through the social networking website, wherein the list includes one or more advertisements that are ordered based on the first and second ratings;
determining the number of advertisements that can be presented to the user of the social networking web site; and
selecting one or more advertisements from the list of advertisements based on the number of advertisements that can be presented to the user,
wherein the selected one or more advertisements are ordered higher in the list of advertisements than those advertisements not selected.

20. The one or more computer-readable storage media of claim 19, further comprising:
receiving information describing the user's interactions with a product promoted by one or more of the selected advertisements.
